(19) United States
(12) Patent Application Publication
(10) Pub. No.: US 2025/0229431 A1
(43) Pub. Date: Jul. 17, 2025

(54) MOBILE ROBOT WITH AN ACOUSTIC SENSING SYSTEM

(71) Applicant: THE ROYAL INSTITUTION FOR THE ADVANCEMENT OF LEARNING/MCGILL UNIVERSITY, Montréal (CA)

(72) Inventors: Audrey SEDAL, Montreal (CA); Wilfred MASON, Laval (CA); David BRENKEN, North York (CA); Alistair XHAYET, Purchase, NY (US)

(21) Appl. No.: 19/024,578

(22) Filed: Jan. 16, 2025

Related U.S. Application Data
(60) Provisional application No. 63/621,345, filed on Jan. 16, 2024.

(51) Int. Cl. B25J 9/16; B25J 5/00; B25J 19/02

(52) U.S. Cl. CPC B25J 9/1694; B25J 5/00; B25J 19/026

(57) ABSTRACT

An acoustic sensing system for a mobile robot, has: a member configured to undergo a periodic motion relative to the frame upon movement of the mobile robot; an acoustic waveguide mounted to the member and being deformable upon contact with the surface; a sound emitting unit and a sound receiving unit mounted to the acoustic waveguide and in communication with the internal volume; and a controller having a processing unit operable to: cause the sound emitting unit to emit sound waves in the internal volume of the acoustic waveguide; receive sound data by the sound receiving unit, the sound data including amplitudes of the sound waves being reflected by the acoustic waveguide and received by the sound receiving unit; and determine information about a profile of the surface based on the sound data.

### CROSS-REFERENCES TO RELATED APPLICATIONS

This application claims benefit of U.S. provisional application No. 63/621,345 filed on Jan. 16, 2024, the entire contents of which are incorporated by reference herein.

### TECHNICAL FIELD

The disclosure relates generally to mobile robots and robotics and, more particularly, to systems and methods used for enabling contact-based inferences of a geometry and properties of obstacles and surfaces.

### BACKGROUND

Autonomous vehicles and mobile robots usually rely on vision and ranging-based instruments to map their surroundings. However, these instruments suffer from occlusions and may fail to perform adequately in low-light and obscuring weather conditions or in the presence of shadows. In contrast, tactile sensors, which gather data from physical interactions with obstacles and surfaces, are not sensitive to external lighting or weather conditions. Tactile sensors (e.g. resistive, piezoelectric, capacitive, optoelectronic, magnetic proximity) have been used to detect and localize contact with obstacles and surfaces, as well as to characterize contact forces and predict incipient slip. However, improvements remain possible in this field.

### SUMMARY

In accordance with one aspect, there is provided an acoustic sensing system for a mobile robot, comprising: a member movably mountable to a frame of the mobile robot, the member configured to undergo a periodic motion relative to the frame upon movement of the mobile robot relative to a surface; an acoustic waveguide mounted to the member, the acoustic waveguide defining an internal volume and having a ground-engaging surface being deformable upon contact with the surface; a sound emitting unit mounted to the acoustic waveguide and in communication with the internal volume, and a sound receiving unit mounted to the acoustic waveguide and in communication with the internal volume; and a controller operatively connected to the sound emitting unit and to the sound receiving unit, the controller having a processing unit operatively connected to a computer-readable medium and having instructions stored thereon executable by the processing unit to cause the processing unit to: cause the sound emitting unit to emit sound waves in the internal volume of the acoustic waveguide; receive sound data by the sound receiving unit, the sound data including amplitudes of the sound waves being reflected by the acoustic waveguide and received by the sound receiving unit; and determine information about a profile of the surface based on the sound data.

The acoustic sensing system as defined above and described herein also includes, in certain embodiments, one or more of the following features, in whole or in part, and in any combination.

In certain embodiments, the instructions cause the processing unit to determine the information about the profile of the surface based on the sound data by: identifying one or more features in or beneath the surface by comparing baseline sound data and the sound data, the baseline sound data being representative of the acoustic waveguide moving on a reference surface being co-planar.

In certain embodiments, the baseline sound data includes baseline amplitudes as a function of distances between the sound receiving unit and a contact area between the acoustic waveguide and the reference surface, the identifying of the one or more features include: receiving a position of the acoustic waveguide relative to the mobile robot, the position indicative of a distance along the acoustic waveguide between the sound receiving unit and a contact area between the acoustic waveguide and the surface; and determining differences between expected amplitudes at the position from the baseline amplitudes and the amplitudes of the sound waves.

In certain embodiments, a sensor operatively connected to the member, the sensor operable to generate a signal indicative of a position of the acoustic waveguide relative to the mobile robot.

In certain embodiments, the sensor is an encoder operatively connected to a motor drivingly engaged to the member.

In certain embodiments, the acoustic sensing system further comprises: characterizing the one or more features based on the differences between the expected amplitudes and the baseline amplitudes.

In certain embodiments, the acoustic sensing system obtains the baseline sound data by performing a calibration sequence including: causing the sound emitting unit to emit the sound waves in the internal volume as the acoustic waveguide moves relative to and in contact with the reference surface; and receiving the baseline sound data by the sound receiving unit.

In certain embodiments, the calibration sequence further includes: removing parasitic noise by performing a low-pass filtering of the baseline sound data.

In certain embodiments, the instructions cause the processing unit to: receive baseline sound data generated by the sound emitting unit, the baseline sound data including the amplitudes of the sound waves reflected by the acoustic waveguide and received by the sound receiving unit over a period of time and at a sampling frequency when the acoustic waveguide is stationary relative to the surface; receive actual sound data generated by the sound emitting unit, the actual sound data including the amplitudes of the sound waves reflected by the acoustic waveguide and received by the sound receiving unit over the period of time and at the sampling frequency when the acoustic waveguide moves relative to the surface; and compute the sound data by subtracting the baseline sound data from the actual sound data.

In certain embodiments, the sound emitting unit and the sound receiving unit are components of an acoustic range finder.

In certain embodiments, the member is a wheel rollingly mounted to the frame of the mobile robot.

In accordance with another aspect, there is also provided mobile robot equipped with the acoustic sensing system as defined in any one or more of the above paragraphs. The mobile robot may for example be a wheeled robot or a legged robot.

In accordance with a further aspect, there is also provided a method for characterizing a surface on which a mobile robot travels, the method comprising: emitting sound waves in an internal volume of an acoustic waveguide, the acoustic waveguide being mounted to a member of the mobile robot that moves with movements of the mobile robot relative to the surface; receiving sound data including amplitudes of the sound waves being reflected by the acoustic waveguide; and determining information about a profile of the surface based on the sound data.

The method as defined above and described herein also includes, in certain embodiments, one or more of the following features and/or steps, in whole or in part, and in any combination.

In certain embodiments, the determining of the information about the profile of the surface based on the sound data includes: identifying one or more features in the surface by comparing baseline sound data and the sound data, the baseline sound data being representative of the acoustic waveguide moving on a reference surface being co-planar.

In certain embodiments, the baseline sound data includes baseline amplitudes as a function of distances between the sound receiving unit and a contact area between the acoustic waveguide and the reference surface, the identifying of the one or more features include: receiving a position of the acoustic waveguide relative to the mobile robot, the position indicative of a distance along the acoustic waveguide between the sound receiving unit and a contact area between the acoustic waveguide and the surface; and determining differences between expected amplitudes at the position from the baseline amplitudes and the amplitudes of the sound data.

In certain embodiments, a signal is received from a sensor indicative of a position of the acoustic waveguide relative to the mobile robot.

In certain embodiments, the sensor is an encoder operatively connected to a motor drivingly engaged to the member.

In certain embodiments, the method further comprises: characterizing the one or more features based on the differences between the expected amplitudes and the baseline amplitudes.

In certain embodiments, obtaining the baseline sound data by performing a calibration sequence includes: causing the sound emitting unit to emit the sound waves in the internal volume as the acoustic waveguide moves relative to and in contact with the reference surface; and receiving the baseline sound data by the sound receiving unit.

In certain embodiments, the calibration sequence further includes: removing parasitic noise by performing a low-pass filtering of the baseline sound data.

In the present disclosure, acoustic sensing over a larger area with a limited number of transducer elements is achieved using acoustic waveguides. These sensors rely on time-of-flight measurements and signal amplitude variations from time-domain reflection and transmission data to localize contact, measure contact forces, and characterize different deformations arising from physical interactions with the waveguide.

In this disclosure, an integration of an acoustic waveguide-based sensor integrated on a wheel of a mobile robot or autonomous vehicle is provided and operable for contact-based obstacle detection and terrain mapping. By using a hollow and flexible tube as an acoustic waveguide, it may be possible to perform tactile sensing along the entire wheel without requiring an array of sensors.

In one aspect, there is provided a system including an acoustic sensing mechanism for obstacle detection and terrain mapping embedded in a wheel of a robot. In another aspect, there are provided hybrid models for fusing wheel position and acoustic reflection data to gain insight into the physical interactions of the disclosed robot within its environment. In yet another environment, there is provided the design of a low-cost and easy-to-deploy acoustic sensing architecture that may be resistant to deformations arising from interactions with different obstacles and terrains in the environment, as well as to external conditions where cameras and LiDAR traditionally fail (e.g. low-light, fog, rain, snow). Altogether, acoustic waveguide-based tactile sensors may enable autonomous vehicles and wheeled mobile robots to detect and characterize features in the terrain that are difficult to “observe” with camera and LiDAR systems or existing tactile sensors.

In one aspect, there is provided a ground vehicle comprising: a frame; a member mounted to the frame and being movable relative to a surface; a motor mounted to the frame and engaged to the member; an acoustic waveguide mounted to the member and defining an internal volume, the acoustic waveguide configured for deforming upon contact with the surface to change a shape of the internal volume; a sound emitting and receiving device mounted to the acoustic waveguide and in communication with the internal volume; and a controller operatively connected to the motor and to the sound emitting and receiving device, the controller having a processing unit operatively connected to a computer-readable medium and having instructions stored thereon executable by the processing unit to cause the processing unit to: cause the motor to move the member relative to the surface; and perform a feature-finding sequence including: causing the sound emitting and receiving device to emit sound waves in the internal volume of the acoustic waveguide; receiving sound data generated by the sound emitting and receiving device, the sound data including amplitudes of the sound waves being reflected by the acoustic waveguide and received by the sound emitting and receiving device over a period of time and at a sampling frequency; and identifying a feature in the surface by finding an amplitude peak in the sound data.

The ground vehicle as defined above and described herein may also include any one or more of the following features, in whole or in part, and in any combination.

In some embodiments, the instructions cause the processing unit to: receive baseline sound data generated by the sound emitting and receiving device, the baseline sound data including the amplitudes of the sound waves reflected by the acoustic waveguide and received by the sound emitting and receiving device over the period of time and at the sampling frequency when the acoustic waveguide is stationary relative to the surface; receive actual sound data generated by the sound emitting and receiving device, the actual sound data including the amplitudes of the sound waves reflected by the acoustic waveguide and received by the sound emitting and receiving device over the period of time and at the sampling frequency when the acoustic waveguide moves relative to the surface; and compute the sound data by subtracting the baseline sound data from the actual sound data.

In some embodiments, the instructions cause the processing unit to perform the feature-finding sequence over a plurality of detection cycles at a detection frequency as the member is moving relative to the surface.

In some embodiments, the sound emitting and receiving device is an acoustic range finder.

In some embodiments, the ground vehicle is a robot, the member is a wheel and the acoustic waveguide is mounted around the wheel.

In another aspect, there is provided a mobile robot comprising: a wheel mounted for rotation relative to a surface; an acoustic waveguide mounted to the wheel and defining an internal volume, the acoustic waveguide configured for deforming upon contact with the surface to change a shape of the internal volume; a sound emitting and receiving device mounted to the acoustic waveguide and in communication with the internal volume; and a controller operatively connected to the sound emitting and receiving device, the controller having a processing unit operatively connected to a computer-readable medium and having instructions stored thereon executable by the processing unit to cause the processing unit to: perform a feature-finding sequence including: causing the sound emitting and receiving device to emit sound waves in the internal volume of the acoustic waveguide; receiving sound data generated by the sound emitting and receiving device, the sound data including amplitudes of the sound waves being reflected by the acoustic waveguide and received by the sound emitting and receiving device over a period of time and at a sampling frequency; and identifying a feature in the surface by finding an amplitude peak in the sound data.

The mobile robot as defined above and described herein may also include any one or more of the following features, in whole or in part, and in any combination.

In some embodiments, the instructions cause the processing unit to: receive baseline sound data generated by the sound emitting and receiving device, the baseline sound data including the amplitudes of the sound waves reflected by the acoustic waveguide and received by the sound emitting and receiving device over the period of time and at the sampling frequency when the acoustic waveguide is stationary relative to the surface; receive actual sound data generated by the sound emitting and receiving device, the actual sound data including the amplitudes of the sound waves reflected by the acoustic waveguide and received by the sound emitting and receiving device over the period of time and at the sampling frequency when the acoustic waveguide moves relative to the surface; and compute the sound data by subtracting the baseline sound data from the actual sound data.

In some embodiments, the instructions cause the processing unit to perform the feature-finding sequence over a plurality of detection cycles at a detection frequency as the member is moving relative to the surface.

In some embodiments, the sound emitting and receiving device is an acoustic range finder.

### BRIEF DESCRIPTION OF THE DRAWINGS

Reference is now made to the accompanying figures in which:

FIG. 1 is a three dimensional view of a mobile robot, depicted as a robot, in accordance with one embodiment, the mobile robot having an acoustic sensing system;

FIG. 2 is a schematic cross-sectional view of an acoustic waveguide of the acoustic sensing system of the robot of FIG. 1 illustrating an interaction with a surface;

FIG. 3 is a graph representing a variation of a time required for a detection of a sound wave impacting an indent created by the surface on the acoustic waveguide of FIG. 2 within a ranging cycle as a function of start times of the ranging cycles;

FIG. 4 is a schematic view of the acoustic waveguide when contacting an obstacle;

FIG. 5 is a graph illustrating a signal provided by a sound emitting and receiving unit for a single detection cycle;

FIG. 6 illustrates a process of assembling sound data obtained from sound emitting and receiving unit over a plurality of detection cycles;

FIG. 7 is a three dimensional view of another embodiment of a wheel and acoustic waveguide for the robot of FIG. 1; and

FIG. 8 is a three dimensional view of another embodiment of a wheel for the robot of FIG. 1; and

FIG. 9 is a three dimensional view of yet another embodiment of a wheel for the robot of FIG. 1;

FIG. 10 is a three dimensional view of an acoustic waveguide in accordance with another embodiment;

FIG. 11 is a flowchart illustrating steps of a method of detecting a feature in a surface in contact with the acoustic waveguide of the robot of FIG. 1;

FIGS. 12A-12B are schematic views of a legged robots, namely a biped robot and a quadruped robot, respectively, in accordance with embodiments;

FIGS. 13A-13B are schematic views of a foot of the legged robots of FIGS. 12A-12B; and

FIG. 14 is a schematic representation of a controller of a computing device used with the acoustic sensing system.

### DETAILED DESCRIPTION

### Introduction

Tactile sensors may be used for contact localization, contact force prediction, and dynamic tactile stimuli classification. Yet, a challenge that exists with known systems is scalability, when sensing over large surfaces. Although tactile sensors may be used for terrain classification and obstacle detection tasks in legged mobile robots, their integration in wheeled mobile robots and autonomous vehicles remains a challenge. The present disclosure pertains to the use of sensors for mobile robots, such as for example mobile robots and ground vehicles, whether autonomous or operated by a user.

### Mobile Robot

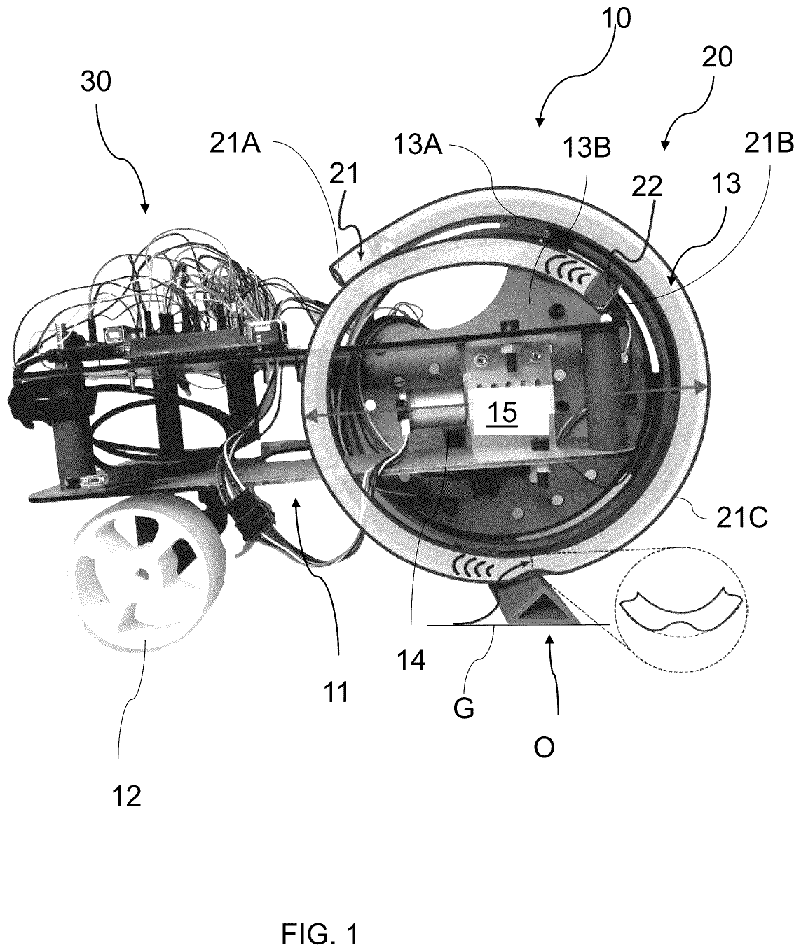

Referring to FIG. 1, a mobile robot is shown at 10. The mobile robot 10 is intended to encompass any device using wheels or other rotating device (e.g., endless track) for its displacement along a surface, such as the ground. The mobile robot 10 may be an autonomous vehicle, a mobile robot, a remote-controlled robot, a user-operated vehicle, and so on. The mobile robot 10 may be, for instance, an automobile. The principles of the present disclosure may apply to any wheeled vehicles (e.g., cars, bicycles, tanks, etc.) as well as other types of robots, including legged robots (e.g., biped, quadruped, and so on) that may benefit from detecting objects on a surface the ground vehicle is interacting with. The principles of the present disclosure are however equally applicable to other devices such as robotic hands, other robotic systems, and so on.

The mobile robot 10 includes a frame 11. Rear wheels 12 are pivotably mounted to the frame 11. The wheels 12 may be idler wheels in that they may not provide motive power to the 10. Alternatively, the wheels 12 may be motorized. The mobile robot 10 includes a member 13 (e.g., a rotatable member, such as a wheel) mounted to the frame 11 and being movable relative to a surface. The surface may be ground or any surface over which the mobile robot travels. In the embodiment shown, the member corresponds to a wheel 13 pivotably mounted to the frame 11. It will be appreciated that the member 13 may be any suitable device configured to undergo a periodic motion relative to the frame 11 upon movements of the mobile robot 10 relative to the surface. Put differently, the member 13 may be an endless track for instance. The member 13 need not be motorized and may be a idler wheel or track that undergo the periodic motion as a result of the mobile robot 10 moving on the surface and the member 13 contacting the surface. A motor 14, which may be equipped with an encoder 15, which may be a magnetic encoder, is mounted to the frame 11 and is drivingly engaged to the wheel 13. The encoder 15 is configured to record an angular position of the front wheel 13. The motor 14 may alternatively, or in combination, drivingly engage the rear wheels 12. The wheel 13 includes a rim 13A and a hub 13B surrounded by the rim 13A.

The mobile robot 10 includes a acoustic sensing system 20, which may also be referred to herein as a contact-sensing system. The 20 includes an acoustic waveguide 21, a sound emitting unit and a sound receiving unit operatively connected to the acoustic waveguide 21. In the present embodiment, these two units are integrated into a single sound emitting and receiving unit 22. However, it will be appreciated that these units may be separate and located at different locations within the acoustic waveguide 21. Additionally, there may be more than one sound emitting unit and/or more than one sound receiving unit connected to the acoustic waveguide. The acoustic waveguide 21 is wrapped around the rim 13A and is partially received within an annular groove defined by the rim 13A. Other ways of securing the acoustic waveguide 21 to the front wheel 13 are contemplated without departing from the scope of the present disclosure. The acoustic waveguide 21 defines a surface 21C, also referred to as a ground-engaging surface, that interacts with a surface on which on which the mobile robot 10 is rolling. The surface 21C may be directly in contact with the surface or, alternatively, may be engaged to an intermediate component that is in contact with the surface as long as deflection imparted on this intermediate component is also imparted on the acoustic waveguide 21 once the wheel 13 rolls over an obstacle O. The acoustic waveguide 21 may be wrapped once around the rim 13A, or, alternatively, wrapped multiple times around rim 13A. The acoustic waveguide 21 may, in certain embodiments, be integrated into or form part of, a while and/or a tire of a road vehicle (e.g., car, bike, etc.).

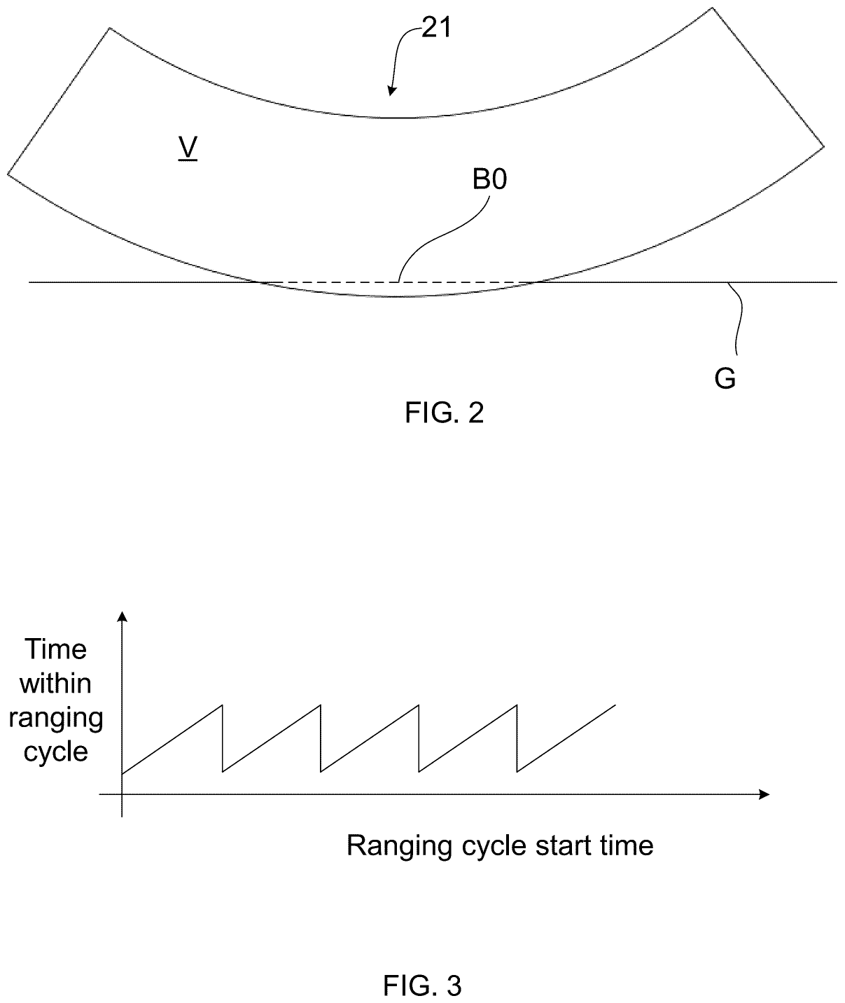

The acoustic waveguide 21 is used to constrain a sensing volume or detection zone of the sound emitting and receiving unit 22 to the volume of air contained within the acoustic waveguide 21. Hence, the sound emitting and receiving unit 22 is not per se able to detect objects located outside the acoustic waveguide 21 since the sound waves are confined within an internal volume V (FIG. 2) of the acoustic waveguide 21. Put differently, the sound emitting and receiving unit 22 detects deformation imparted by these objects on the acoustic waveguide 21 rather than the objects themselves. The acoustic waveguide 21 extends from a first end 21A to a second end 21B. In the present embodiment, the first end 21A is open but may, in certain embodiments, be closed or plugged with a sound absorbing material. A length of the acoustic waveguide 21 between the first end 21A and the second end 21B may be greater than a circumference of the wheel 13 such that an overlap may be created. A length of the overlap may be about 2.5 cm for a radius of the wheel 13 of about 13.5 cm; the radius extending from a rotation axis of the wheel 13 to the surface 21C of the acoustic waveguide 21 that contacts the surface. Hence, the overlap may be about 18% to 20% of the radius of the wheel 13. Other dimensions are contemplated. The overlap may constitute a dead zone of the acoustic waveguide 21. A portion of the acoustic waveguide 21 that extends from the second end 21B towards the overlap may be located radially inward of the rim 13A relative to the rotation axis of the wheel 13. This portion may be secured to the hub 13B

In the present embodiment, the acoustic waveguide 21 is a tube made of silicone rubber or any other suitable material. The tube may have a circular cross-section, but other shapes, such as ellipsoid or oval are contemplated. A diameter of the acoustic waveguide 21 may be about 19.05 mm, but other dimensions are contemplated. A thickness of the acoustic waveguide 21 may be about 1.6 mm. A bend radius of the waveguide may be about 38 mm. The bend radius of the tube is measured at an inside curvature of the tube when curved and defines the minimum radius one can bend the tube while avoiding kinking of the tube. The inner and outer diameters of the tube, its hardness, and the wall thickness may be varied depending of the size of the front wheel 13 of the mobile robot 10. For instance, the material and dimensions of the tube may be selected to prevent buckling or kinking of the tube when wrapped around the wheel and nested in the hub 13B and to achieve the desired level of tube compression (or deformation) when contacting the surface. In some embodiments, a localized deformation of the acoustic waveguide 21 when contacting the surface should be at least about 30% of the outer diameter of the acoustic waveguide 21.

### Sensor

The sound emitting and receiving unit 22 is mounted to the acoustic waveguide 21 and is in communication with the internal volume V (FIG. 2) of the acoustic waveguide. The sound emitting and receiving unit 22 is operable to generate a signal indicative of sound data captured by the sound emitting and receiving unit 22. While in certain embodiments the sound emitting and receiving unit 22 may be a single integrated sensor, in alternate embodiments the two functions may be separated, wherein the sound emitting unit is separate from the sound receiving unit. The sound emitting and receiving unit 22 include a microphone in some embodiments. The sound data may include, for instance, an amplitude of the sound. In the embodiment shown, the sound emitting and receiving unit 22 is an acoustic range finder, which may be obtained from the company MaxBotix™ model no. MP1010 LV-MaxSonar-EZ1. The sound emitting and receiving unit 22 is secured to the second end 21B of the acoustic waveguide 21 and is located within the acoustic waveguide 21. It may be located at any suitable locations within the acoustic waveguide 21. The first end 21A of the acoustic waveguide 21 may be left open and, thus, an interior of the acoustic waveguide 21 may be fluidly connected to an environment outside thereof. Hence, ambient air may enter the acoustic waveguide 21. In alternate embodiment, the first end 21A may be closed and a dampening material may be located in the acoustic waveguide 21 to prevent an acoustic signal generated by the acoustic range finder from bouncing back. The sound emitting and receiving unit 22 may include more than one sensors in some embodiments. The sound emitting and receiving unit 22 may include a sound emitting device (e.g., an ultrasound generator, speaker, etc) separated from a sound receiving device (e.g., acoustic sensor, microphone, etc) in some embodiments. Alternatively, the sound emission function and the sound detection function may be carried by the same unique device. The acoustic waveguide 21 contains air in this embodiment, but other fluid are contemplated, such as water, gel, etc. The acoustic waveguide 21 may be pressurized at a pressure above atmospheric pressure.

An acoustic range finder is a kind of sensor used to measure distances to remote objects. The acoustic range finder of this embodiment emits square-wave pulses at an emission frequency, which may in a particular embodiment be about 42.5 kHz. The frequency may be any suitable frequencies above a human max hearing frequency. For instance, the frequency may be from about 20 KHz to about 20 MHz. The range finder may be queried at 20 Hz (50 ms detection window). In other words, the emissions may be emitted in burst. A frequency of these bursts may be at least 20 Hz to minimize ringing. The signal may be sent as an 8-pulse train. Any suitable frequencies may be used. The sound waves, or pulses, bounce on an object located in a detection zone of the range finder and a sound wave is reflected back by the object towards the range finder. As described above, the detection zone corresponds to an inner volume of the acoustic waveguide 21. The distance between the range finder and the object may be calculated by recording the time between the sending and the receiving of the square-wave pulses and based on the speed of sound in a medium in which the sound travels. In the present embodiment, the medium is air, but other fluid may be used in alternate embodiment. Also, the medium may be material, such as an architected material (e.g., lattice structure, 3D printed structure, and so on).

Referring to FIG. 2, a portion of the acoustic waveguide 21 that contacts the ground or surface G is shown. As one can appreciate, the weight of the mobile robot 10 causes a deflection in the acoustic waveguide 21. Hence, an inner face of the acoustic waveguide 21 defines a contact point or contact patch, which will be referred to as a baseline profile B0, which may in certain instances form a flattened region or a bump, and thus has a shape that corresponds to a contact area between the acoustic waveguide 21 and the surface G when the acoustic waveguide 21 contacts the surface G. The sound waves emitted by the sound emitting and receiving unit 22 impact this contact patch B0 and are rejected back towards the sound emitting and receiving unit 22. Since the sound emitting and receiving unit 22 rotates with the front wheel 13, and since the point of contact between the acoustic waveguide 21 and the surface G changes location as the front wheel 13 turns about its rotation axis, the distance S between the point of contact (i.e., contact patch B0) and the sound emitting and receiving unit 22 varies with rotation of the wheel 13. Consequently, the time it takes for the sound waves to bounce back to the sound emitting and receiving unit 22 increases with the distance between the sound emitting and receiving unit 22 and the contact patch B0.

Referring now to FIG. 3, a variation of a time required for a pulse to impact the contact patch B0, which herein represents the contact point or a contact area between the waveguide and the surface G, and reach the sound emitting and receiving unit 22 for each ranging cycle is plotted. Values of start times of the ranging cycles are on the abscissa. As one can appreciate, this variation is cyclic since the distance between the contact patch B0 and the sound emitting and receiving unit 22 continuously increases from a minimum, when the contact patch B0 is located proximate the second end 21B of the acoustic waveguide 21, to a maximum when the contact patch B0 is proximate or at the first end 21A.

As shown on FIG. 1, a controller 30 is mounted to the frame 11 and operatively connected to the sound emitting and receiving unit 22. The controller 30 may be operatively connected to the encoder 15 and to the motor 14 to control movements of the mobile robot 10. The controller 30 is operable to process the signals received from the sound emitting and receiving unit 22 as will be discussed below. A through-hole type or slip-ring connector may be used to operatively connect the sound emitting and receiving unit 22 to the controller 30. Any suitable connections may be used. The encoder 15 is used to supply data to the controller 30 about the position (e.g., angular position) of the wheel.

### Sound Data

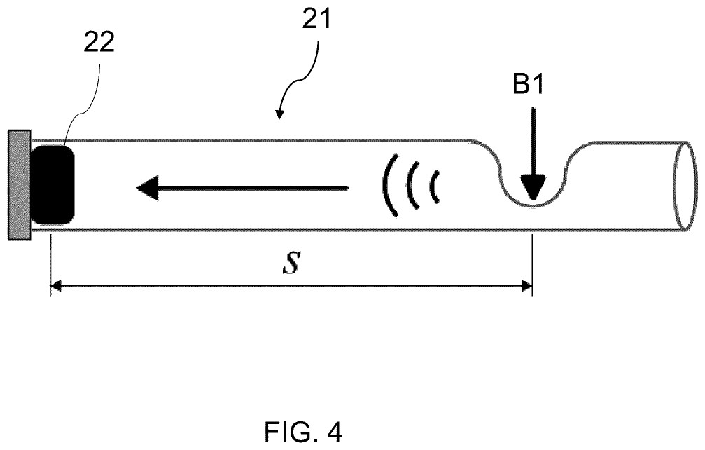

Referring to FIG. 4, a raw signal generated by the sound emitting and receiving unit 22 is plotted. The graph presents an amplitude of the sound received by the sound emitting and receiving unit 22 for each of a plurality of samples. A sample corresponds to an event in which the controller 30 communicates with the sound emitting and receiving unit 22 to obtain its signal. Each of those samples has been communicated from the sound emitting and receiving unit 22 to the controller 30 at a respective time. The sound emitting and receiving unit 22 typically works by emitting sound waves at a given time and then listening for an echo generated by those sound waves when they bounce back on an object in its detection volume. In some embodiments, a sampling frequency, which denotes a frequency at which the controller 30 communicates with the sound emitting and receiving unit 22 to obtain its signal, is greater than the emission frequency of the sound emitting and receiving unit 22 at which the sound emitting and receiving unit 22 emits the sound waves. A resolution may be increased by increasing the emission frequency. In other words, a more detailed representation of the surface on which the mobile robot 10 rolls may be obtained by increasing the emission frequency of the sound emitting and receiving unit 22. In some embodiments, the sampling frequency is about 200 kilo-samples per seconds (KSPS).

As shown in FIG. 4, the sound emitting and receiving unit 22 is sampled for about 1000 times before the sound emitting and receiving unit 22 emits the sound waves. From about 1000 to 1300, the sound detected by the sound emitting and receiving unit 22 actually corresponds to the sound waves it generates. Then, from about 1300 to 1700, the signal propagates and the sound emitting and receiving unit 22 does not detect much sound. At about 1700 to 1800, the sound emitting and receiving unit 22 detects the reflected waves (e.g., echo) that bounced back on an obstacle in the detection zone. The time between the emission of the sound waves and the detection of the reflected sound waves is indicative of the distance between the sound emitting and receiving unit 22 and the obstacle since the speed at which the sound waves travel corresponds to the speed of sound. Also, the amplitude of the sound waves reflected back to the sound emitting and receiving unit 22 may be used to gather information about the obstacle as will be discussed below.

It will be appreciated that the sound emitting and receiving unit 22 may be any device able to generate a signal when receiving a sound wave. The sound waves may be emitted by another device (e.g., speaker) separate from the sound emitting and receiving unit 22. In the present embodiment, the sound emitting and receiving unit 22 both emits and receives sound waves, but this need not be the case.

Detection of Obstacles and/or Features

The description below explains steps performed by the controller 30 to identify an obstacle (or a feature (e.g., a surface feature, or a feature beneath the surface), which may not necessarily be an obstacle) on the surface G.

Referring to FIG. 4, a portion of the acoustic waveguide 21 is illustrated and shows a profile B1 or dimple generated by the obstacle O. This obstacle O creates a deformation of the, otherwise flat, baseline profile B0 (FIG. 2) of the acoustic waveguide 21 when contacting a generally flat surface. Put differently, the obstacle O will vary a shape of the contact patch. The obstacle O therefore generates a shape variation from the baseline profile B0 to a deformed profile B1. The sensing system 20 may detect variation of the profile from the baseline profile B0 to the deformed profile B1 to identify features in a surface.

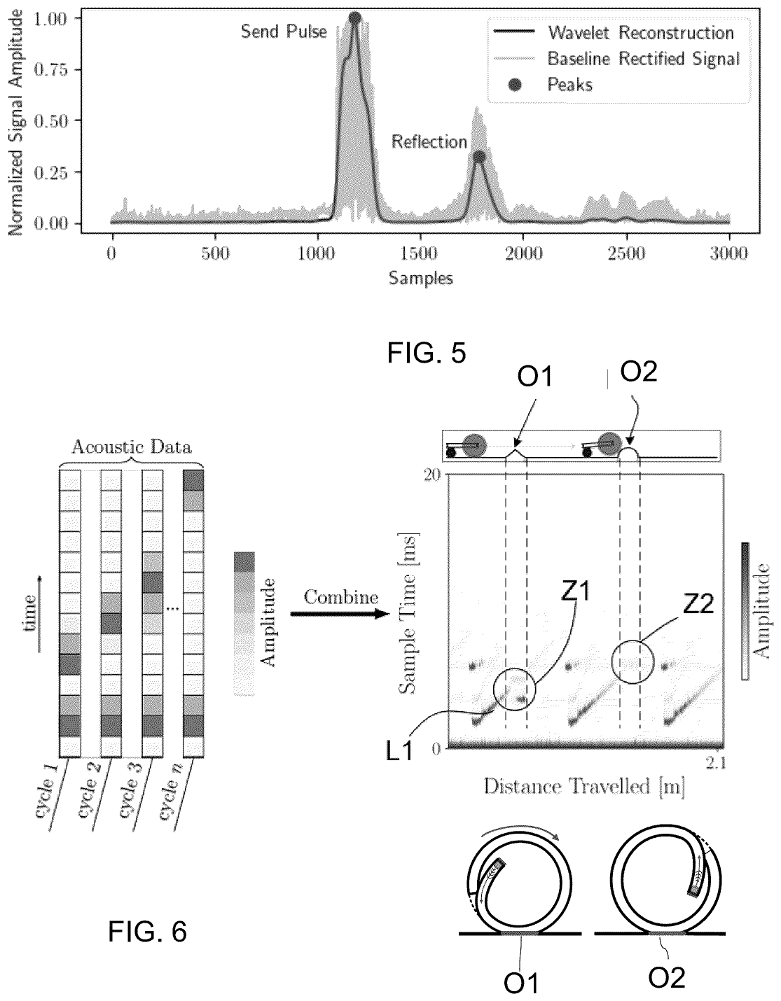

The controller 30 stores the acoustic data from each ranging cycle. A ranging cycle may refer to a sequence of sound wave emissions and reflected sound wave detection. The controller 30 may choose how many ranging cycles to perform for a given period of time (e.g., 10 cycles per second). For each cycle, the controller 30 triggers the sound emitting and receiving unit 22 to emit the sound waves and wait for the sound emitting and receiving unit 22 to intercept the reflected sound waves. Data processing and feature extraction from the acoustic data (shown in FIG. 5) may also be completed on the controller 30. However, in some cases, this analysis may be performed by another controller. The controller 30 may include a microcomputer (e.g. BeagleBone Black™) for sampling the acoustic signal from each ranging cycle. The acoustic signal may be sampled at a frequency of 200,000 samples per second without averaging. Put differently, the controller 30 may receive sound data generated by the sound emitting and receiving unit 22 200,000 times per second. These sound data may look like the graph of FIG. 5.

Each experiment may begin with a calibration sequence during which several ranging cycles are executed while the mobile robot 10 is stationary. The calibration data is used to extract predictions for the ground contact position relative to the sensor location at start-up. The calibration cycles also identify positions in the tube in which the acoustic waveguide 21 is consistently pinched (e.g. at the insertion point into the hub 13B). Peaks of amplitude in the sound data received from the sound emitting and receiving unit 22 and corresponding to these positions are located at constant temporal offsets from the sent pulse and may be eliminated. More specifically, as the pulses propagate in the acoustic waveguide 21, they may hit different obstacles, namely, the inner wall of the acoustic waveguide 21, the baseline profile B0 created by the surface G on the acoustic waveguide 21, the bend where the acoustic waveguide 21 moves radially inwardly towards the second end 21B, and so on. Each of these obstacles may be located at different distances and the sound emitting and receiving unit 22 will detect a plurality of corresponding reflected pulses at different time. The calibration sequence may also include a compensation for an attenuation of the sound/vibrations by the waveguide.

Next, the motion of the mobile robot 10 is initiated and a rotational speed of the front wheel 13 may be maintained constant (e.g., 10 RPM). The controller 30 queries a position of the wheel 13 from the encoder 15 before each ranging cycle. The controller 30 may then receive the current position of the front wheel 13 and the acoustic data for each ranging cycle (e.g., 4,000, 16-bit samples).

The controller 30 may be configured to recover a temporal history of contact locations on the acoustic waveguide 21 by performing peak-finding and time-of-flight reflectometry on the acoustic time-series. FIG. 5 illustrates a sample of the processed acoustic signal. To extract the locations of the peaks in each acoustic time-series, the raw signal generated by the sound emitting and receiving unit 22 may be first low-pass filtered. The cut-off frequency (fc) may be 50 Hz. As shown in FIG. 5, for instance between the 1 st and 1000^{th} samples, the signal may not be attributable to any reflected waves and may be cause by parasitic noise and may be filtered out. The filtered signal may be subtracted from the raw signal to set its vertical baseline to zero. This signal may then be rectified by taking its absolute value. Next, a pseudo-envelope which recovers a smoothed profile of the signal without necessarily matching its amplitude is generated.

The sound data represented in FIG. 5 represents the amplitude, which varies between 0 and a given value for each sample. The pseudo-envelope may be seen as a curve that interconnects the “peaks” for each sample. The pseudo-envelope may represent an estimation of a shape of the sound data received from the sound emitting and receiving unit 22 for a given number of samples.

This pseudo-envelope may be estimated by performing a continuous wavelet transform of the rectified signal with Gaussian mother wavelets. The wavelet profile and the scales were chosen to match the shape and extent of the pulses observed in the experimental data. The pseudo-envelope of the signal may be approximated as the scale-averaged wavelet power with the equation below:

$${\overline{W}}^{2} ( n ) = \frac{1}{J} {\sum }_{j = 1}^{J} {\vert W ( {s}_{j} , n ) \vert}^{2}$$

where J is the largest scale value and W(sⱼ,n), is the continuous wavelet transform computed for a particular scale value sⱼ on a discretized signal with n data points. Peaks are identified in the enveloped signal using a peak finding function known in the art. Considering the width of the transmission pulse, the minimum temporal distance between peaks was calculated as:

$$Δ {t}_{min} = \frac{{n}_{cycles} f}{2 c}$$

where n_{cycles} and f are the number of cycles in the sent pulse and the operating frequency of the rangefinder, respectively and c is the speed of sound in air or through any other suitable medium contained in the waveguide. The peaks identified using the peak finding function were then filtered according to a user-defined, relative prominence threshold. Drawing inspiration from topographic prominence, the relative prominence of a peak is constructed as

$${p}_{relative} = \frac{{h}_{peak} - {h}_{contour line}}{{h}_{peak}}$$

where pᵣₑₗₐₜᵢᵥₑ is the relative prominence, hₚₑₐₖ is the height of the peak and h_{contour} line is the height of the lowest contour line. The peaks are further filtered by a minimum height threshold listed in the table below. The spatial distribution of peaks along the length of the acoustic waveguide 21 and for a given ranging cycle may then be plotted to recover the contact history of the wheel 13.

The table below lists the parameters used for peak-finding:

| Parameter | Value(s) |
|---|---|
| Scales [num. of samples] | {10.0, 12.5, 15.0, 17.5, 20.0} |
| Relative Prominence | 5.5(10)⁻¹ |
| Peak Height Threshold | 5.0(10)⁻² |

### Results

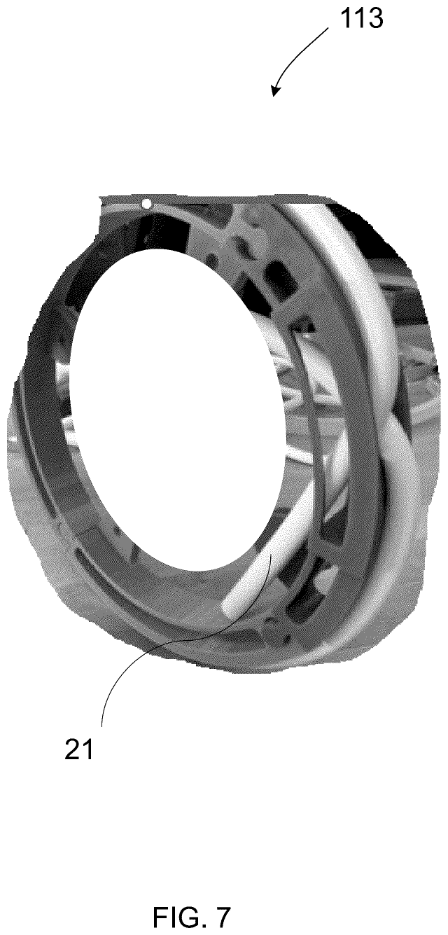

Referring to FIG. 6, to assess the capabilities of the mobile robot 10, acoustic data were gathered by having the mobile robot 10 roll on a surface defining two obstacles referred to as the first obstacle O1 and the second obstacle O2. These obstacles have a height of 2.5 cm. The first obstacle O1 has a triangular profile while the second obstacle O2 has a semi-circular profile.

Acoustic reflections corresponding to the surface contact position of the wheel 13 on the flat terrain and both obstacles is recovered. FIG. 6 corresponds to acoustic data (baseline rectified and enveloped) gathered. For a flat surface, the surface contact traces correspond to diagonal lines L1. It is possible to distinguish the location of the obstacles in the acoustic data. Indeed, zones Z1 and Z2 on FIG. 6 show a perturbation in the diagonal lines L1. The different shapes of the obstacles produced unique traces in FIG. 6. The traces in zone Z1 are different than that in zone Z2. The first obstacle O1 produced two reflections at the contact locations, whereas the second obstacle O2 produced a single reflection. The arrival time(s) of the reflections are related to the angle of reflection of the incoming acoustic waves with the indentation on the waveguide.

Put differently, the graph of FIG. 6 illustrates a plurality of diagonal traces that represents the movement of the contact point between the surface G and the acoustic waveguide 21. When this contact point is close to the sound emitting and receiving unit 22, the time required for the pulse to bounce back and reach the sound emitting and receiving unit 22 is less than if the contact point were further away. As the distance along the acoustic waveguide 21 between the contact point and the sound emitting and receiving unit 22 increase, the more time it takes for the pulse to bounce back and reach the sound emitting and receiving unit 22. With this increase, the amplitude of the reflected sound waves also decreases since it may be at least partially absorbed by the acoustic waveguide 21 when travelling back towards the sound emitting and receiving unit 22. Hence, the amplitude decreases as the distance between the contact point and the sound emitting and receiving unit 22 increases. In FIG. 6, a greater amplitude is represented by a darker shade. The amplitude is also a measure of the deformation imparted to the acoustic waveguide 21 by the obstacle. Put differently, information about the obstacle may be determined from the amplitude. A greater amplitude may imply a bigger obstacle in some cases. However, a greater amplitude may indicate an obstacle that is closer to the sensor. Hence, per cycle, the amplitude of each peak and the number of peaks implies information about the number of contact points, their hardness (via reflectivity) and their proximity to the sound emitting and receiving unit 22. Over a few cycles (e.g., 2+ cycles) information about the obstacle's shape can be determined. This may be done by observing changes in number of peaks and peak amplitude between cycles. Moreover, additional robot information (e.g., knowing what the control parameters were for the vehicle) may be incorporated.

Referring to FIG. 7, another embodiment for the front wheel 13 is shown at 113. This configuration may minimize a size of the dead zone since both ends of the acoustic waveguide 21 are inserted through holes defined in the wheel hub of the front wheel 13. This configuration may avoid ringing effects by introducing an extra length of waveguide which is nested inside the wheel and does not come into contact with the surface (i.e. no reflections can come from this portion of the waveguide).

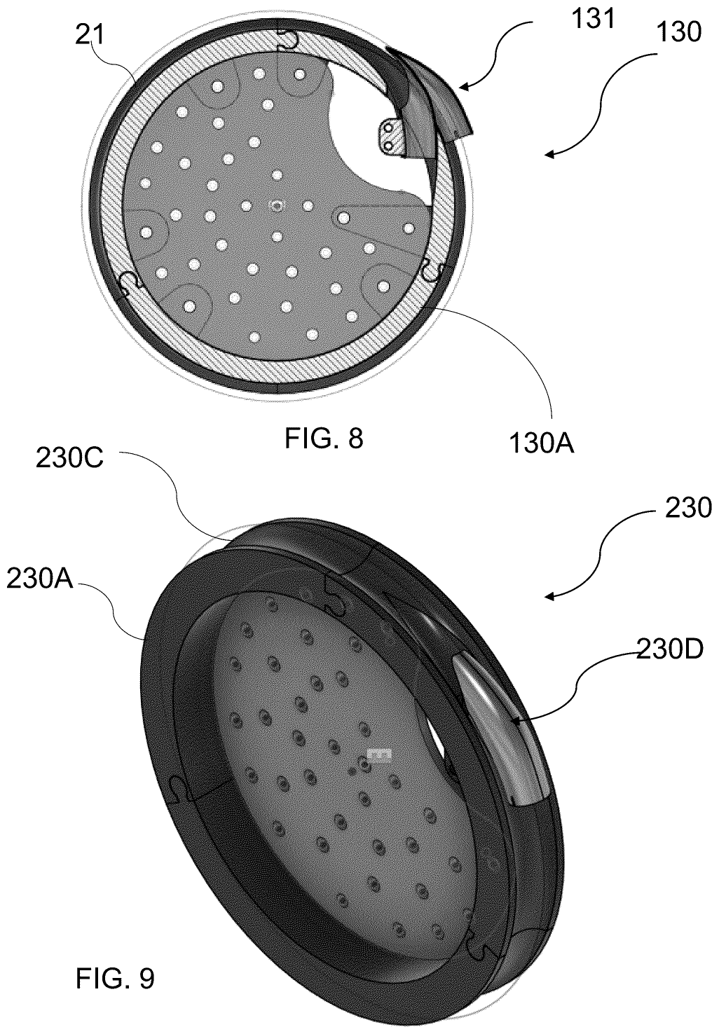

Referring to FIG. 8, another embodiment of a wheel is shown at 130. For the sake of conciseness, only features different from the wheel 13 described above are described below.

In the embodiment shown, the wheel 130 includes a coupler 131. The coupler 131 is secured to the rim 130A of the wheel 130. The coupler 131 is configured to allow the acoustic waveguide 21 to roll smoothly in clockwise or counter-clockwise direction without catching. It mechanically couples both ends of the acoustic waveguide 21 together. The coupler 131 has a body defining two ports one for receiving a first end of the acoustic waveguide 21 and another one receiving the second end of the acoustic waveguide 21. The body of the coupler 131 has a shape that merges radially into the rim 130A to provide a circular rolling surface. The two ports are axially overlapping one another and are radially offset from one another relative to an axis of rotation of the wheel 130. This configuration may avoid the axial offset of the two ends of the acoustic waveguide as shown in FIG. 7.

Referring to FIG. 9, another embodiment of a wheel is shown at 230. For the sake of conciseness, only features different from the wheel 13 described above are described below. In the embodiment shown, the rim 230A defines a concave outer periphery 230C. A shape of this periphery 230C taken on a plane containing an axis of rotation of the wheel 230 is elliptical. Thus, the wheel 13 is able to accommodate acoustic waveguides of different diameters. The rim 230A further defines an aperture 230D via which the acoustic waveguide passes through the rim 230A towards the axis of rotation of the wheel 230. More specifically, the coupler 131 described above may be integrated to the wheel 230 of this embodiment. The aperture 230D is shaped to receive the coupler 131.

### Braided Waveguides

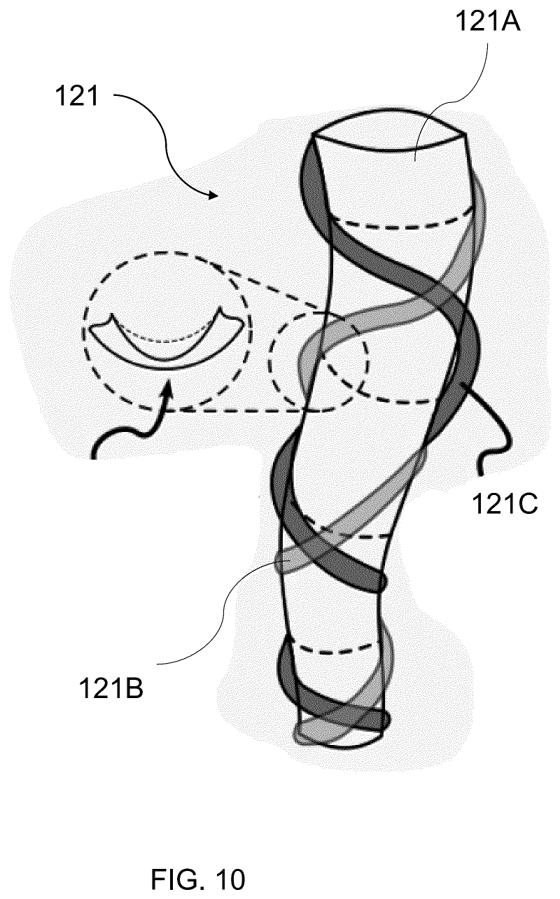

Referring to FIG. 10, another embodiment of an acoustic waveguide is shown at 121. In this embodiment, the acoustic waveguide 121 includes a central tube 121A and one or more peripheral tubes 121B, two peripheral tubes 121B in this embodiment. The three tubes are braided together. For instance, a first one of the two peripheral tubes 121B may be wrapped helicoidally around the central tube 121A in a clockwise direction whereas a second one of the two peripheral tubes 121B may be wrapped helicoidally around the central tube 121A in a counterclockwise direction. Each tubes define a respective internal volume each communicating with a respective sound emitting and receiving unit 22. Such a configuration may improve multi-contact localization capabilities. Put differently, the three tubes may increase a precision in the contact detection. For instance, the member 13 equipped with this waveguide may detect a plurality of features or obstacles for given angular position of the member 13.

### Method

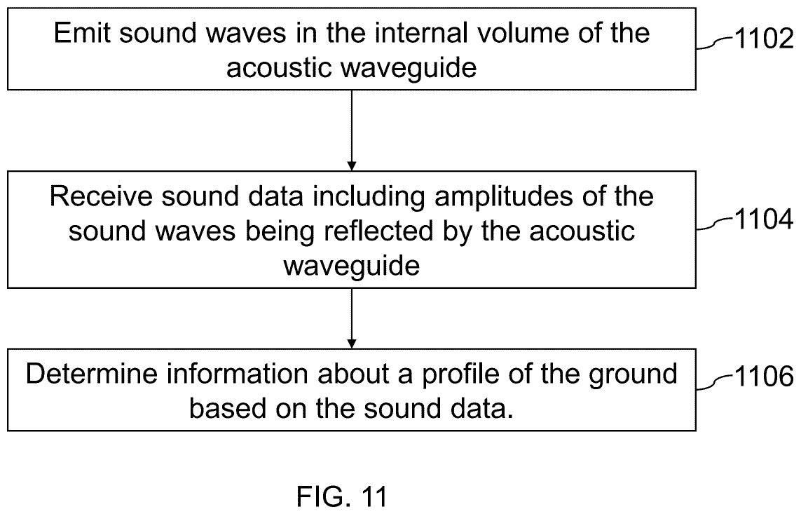

Referring now to FIG. 11, a method of detecting an obstacle is shown at 1100. The method 1100 includes: cause the sound emitting and receiving unit 22 to emit sound waves in the internal volume of the acoustic waveguide 21 at 1102; receive sound data by the sound emitting and receiving unit 22 at 1104. The sound data include amplitudes of the sound waves being reflected by the acoustic waveguide 21 and received by the sound emitting and receiving unit 22. The method 1100 then includes determine information about a profile of the surface based on the sound data at 1106.

As depicted in FIG. 6, a relationship may be established between a distance S between the sound emitting and receiving unit 22 and a contact patch between the acoustic waveguide 21 and the surface. This is referred as the baseline profile B0 of the surface. FIG. 6 illustrates that as the distance along the acoustic waveguide 21 between the sound emitting and receiving unit 22 and the contact patch increases, the amplitude of the sound waves reflected back to the sound emitting and receiving unit 22 decreases. This is due to dampening within the acoustic waveguide 21.

In this embodiment, the encoder 15 is used to know this distance S. In other words, the encoder 15 provides data to the controller about an angular position of the member 13. Based on this angular position, the controller determines the distance between the contact patch and the sound emitting and receiving unit 22. Therefore, a calibration sequence may be performed to detect obstacle using the system 20. This sequence may include, for instance, causing the sound emitting and receiving unit 22 to emit the sound waves in the internal volume as the acoustic waveguide 21 moves relative to and in contact with a reference surface; and receiving baseline sound data by the sound emitting and receiving unit 22. The reference surface may be a flat surface devoid of any obstacle (e.g., bumps, holes, etc). The flat surface or reference surface may be coplanar.

Then, the method 1100 may identifying one or more features in or beneath the surface by comparing the baseline sound data and the sound data. As mentioned, the baseline sound data are representative of the acoustic waveguide moving on the reference surface being co-planar. Thus, any difference between the baseline sound data and the sound data is indicative of a presence of an obstacle on the surface. The obstacle may also be a different texture of the surface. For instance, concrete may be a rough surface and this roughness may be captured by the acoustic waveguide 21.

The baseline sound data may include baseline amplitudes as a function of distances between the sound emitting and receiving unit 22 and the contact area or patch between the acoustic waveguide 21 and the reference surface. The identifying of the one or more features may include: receiving a position of the acoustic wave guide 21 relative to the mobile robot 10, the position indicative of the distance S along the acoustic waveguide 21 between the sound emitting and receiving unit 22 and the contact area between the acoustic wave guide 21 and the surface; and determining differences between expected amplitudes at the position from the baseline amplitudes and the amplitudes of the sound data. A sensor, such as the encoder 15, may be operatively connected to the member 13 and operable to generate a signal indicative of a position of the acoustic waveguide 21 relative to the mobile robot 10.

The method 1100 may include characterizing the one or more features based on the differences between the expected amplitudes and the baseline amplitudes. This characterization may include determining a shape, height, width, depth, and so on of the one or more features. The calibration sequence described above may include having the mobile robot 10 roll over obstacle having known various shapes to determine a signature in the sound data caused by these know shapes. This may be stored in the controller and used as comparison data to allow the controller to identify the obstacles the mobile robot 10 encounters when rolling on an unknown terrain. The calibration sequence may further include removing parasitic noise by performing a low-pass filtering of the baseline sound data.

In some embodiments, the method 1100 includes receiving the baseline sound data generated by the sound emitting and receiving unit 22; receiving actual sound data generated by the sound emitting and receiving unit 22, the actual sound data including the amplitudes of the sound waves reflected by the acoustic waveguide and received by the sound emitting and receiving unit over the period of time and at the sampling frequency when the acoustic waveguide moves relative to the surface; and compute the sound data by subtracting the baseline sound data from the actual sound data.

### Legged Robot

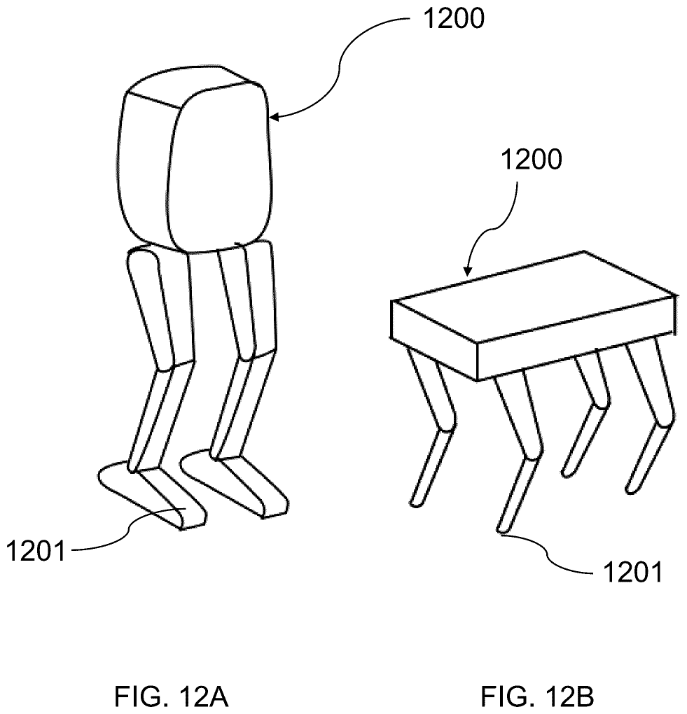

Referring to FIGS. 12A-12B two legged robots 1200 are depicted, namely a biped robot in FIG. 12A and a quadruped robot in FIG. 12B. Both of these legged robots 1200 include feet 1201 via which the robots 1200 interacts with the ground. The legged robots 1200 as described herein may also be other types of ground-engaging legged robots, for example hexapod robots or other. In all cases, however, the foot 1201 of the legged robot 1200 may benefit from the principles of the present disclosure.

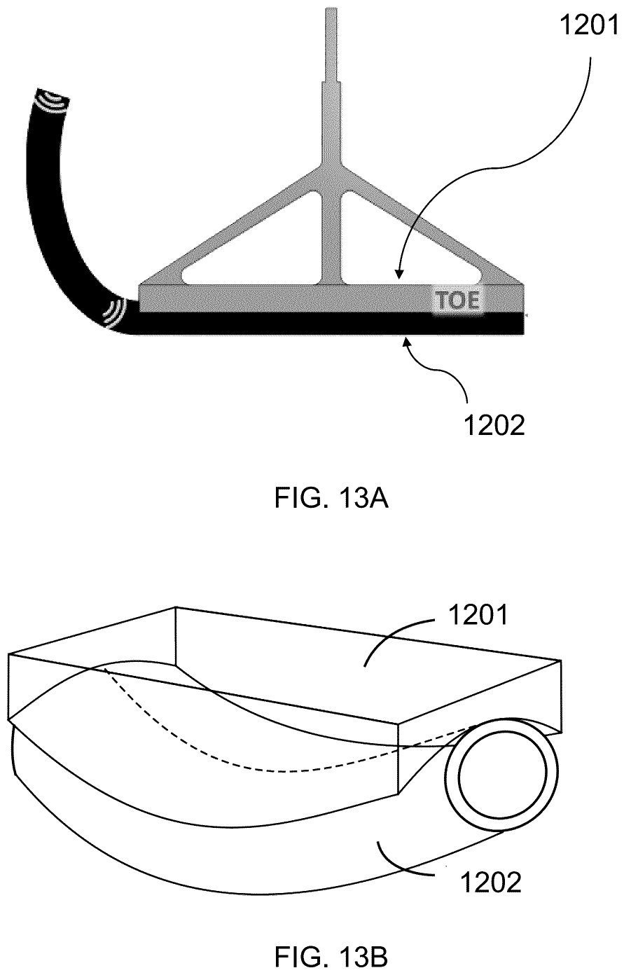

Referring now to FIGS. 13A-13B, the foot 1201 of the legged robot 1200 includes a sole 1202 that is configured for contacting the ground, and integrates therein the acoustic sensing system 20 of the mobile robot 10 described above. The sole 1202 may thus itself include an acoustic waveguide 21 of the acoustic sensing system 20, which is configured to deform upon contact with the ground. A sound emitting unit and a sound receiving unit are in communication with an internal volume of the acoustic waveguide 21 and configured to send information to the robot 1200 about the ground, thereby permitting the legged robot 1200 to detect the presence of obstacles, ground texture, and so on, using the contact-sensing acoustic system described herein.

### CONCLUSIONS

The acoustic sensing system 20 may be used to classify and potentially characterize obstacles. It may be used to map terrain topography based on the history of ground contact traces. Terrain classification may be possible by analyzing the amplitude and width of the ground contact traces. Finally, the sound emitting and receiving unit 22 may be used to detect slip by fusing encoder data from the drive-wheel(s) with amplitude variations from acoustic reflection data at the ground contact locations.

The acoustic sensing system 20 described above may be used in conjunction with many devices such as, for instance, home robot for personal assistance, small vehicles such as electric bicycles, delivery robots, as part of a robotic hand allowing said hand to detect contact with objects, and so on.

The disclosed system may leverage wave propagation phenomena for contact localization, force estimation, and object/surface characterization. The vehicle may conform through deformable sensing interface, may be mechanically robust by decoupling electronic components from the contact surface, may improve trade-off landscape through distributed sensing, and may be used for multi-modal sensing.

### Controller

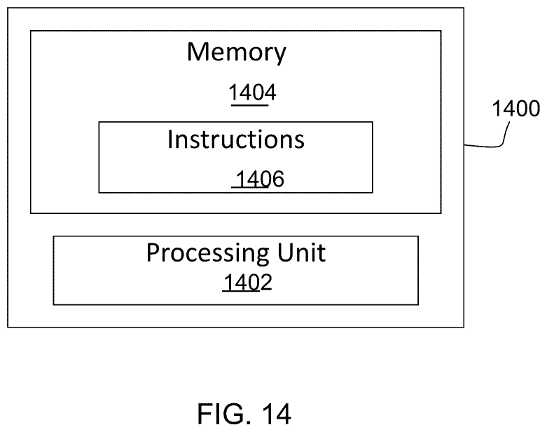

With reference to FIG. 14, an example of a computing device 1400 is illustrated. For simplicity only one computing device 1400 is shown but the system may include more computing devices 1400 operable to exchange data. The computing devices 1400 may be the same or different types of devices. The controller 30 may be implemented with one or more computing devices 1400.

It is to be understood that the term “controller” as used herein is used in its general sense, in that the controller 30 is operable to receive and process information, and may not necessarily actively control operation of the vehicle, for example.

The computing device 1400 comprises a processing unit 1402 and a memory 1404 which has stored therein computer-executable instructions 1406. The processing unit 1402 may comprise any suitable devices configured to implement the method 1100 such that instructions 1406, when executed by the computing device 1400 or other programmable apparatus, may cause the functions/acts/steps performed as part of the method 1100 as described herein to be executed. The processing unit 1402 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 1404 may comprise any suitable known or other machine-readable storage medium. The memory 1404 may comprise non-transitory computer readable storage medium, for example, but not limited to, an electronic, magnetic, optical, electromagnetic, infrared, or semiconductor system, apparatus, or device, or any suitable combination of the foregoing. The memory 1404 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 1404 may comprise any storage means (e.g., devices) suitable for retrievably storing machine-readable instructions 1406 executable by processing unit 1402.

The methods and systems for detecting obstacles described herein may be implemented in a high level procedural or object oriented programming or scripting language, or a combination thereof, to communicate with or assist in the operation of a computer system, for example the computing device 1400. Alternatively, the methods and systems for detecting obstacles may be implemented in assembly or machine language. The language may be a compiled or interpreted language. Program code for implementing the methods and systems for detecting obstacles may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems for detecting obstacles may also be considered to be implemented by way of a non-transitory computer-readable storage medium having a computer program stored thereon. The computer program may comprise computer-readable instructions which cause a computer, or more specifically the processing unit 1402 of the computing device 1400, to operate in a specific and predefined manner to perform the functions described herein, for example those described in the method 1100.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. The term “connected” or “coupled to” may therefore include both direct coupling (in which two elements that are coupled to each other contact each other) and indirect coupling (in which at least one additional element is located between the two elements).

It is further noted that various method or process steps for embodiments of the present disclosure are described in the following description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. The use of the indefinite article “a” as used herein with reference to a particular element is intended to encompass “one or more” such elements, and similarly the use of the definite article “the” in reference to a particular element is not intended to exclude the possibility that multiple of such elements may be present.

In the context of the present disclosure, the expression “about” implies variations of plus or minus 10%.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. An acoustic sensing system for a mobile robot, comprising:
a member movably mountable to a frame of the mobile robot, the member configured to undergo a periodic motion relative to the frame upon movement of the mobile robot relative to a surface;
an acoustic waveguide mounted to the member, the acoustic waveguide defining an internal volume and having a ground-engaging surface being deformable upon contact with the surface;
a sound emitting unit mounted to the acoustic waveguide and in communication with the internal volume, and a sound receiving unit mounted to the acoustic waveguide and in communication with the internal volume; and
a controller operatively connected to the sound emitting unit and to the sound receiving unit, the controller having a processing unit operatively connected to a computer-readable medium and having instructions stored thereon executable by the processing unit to cause the processing unit to:
cause the sound emitting unit to emit sound waves in the internal volume of the acoustic waveguide;
receive sound data by the sound receiving unit, the sound data including amplitudes of the sound waves being reflected by the acoustic waveguide and received by the sound receiving unit; and
determine information about a profile of the surface based on the sound data.

2. The acoustic sensing system of claim 1, wherein the instructions cause the processing unit to determine the information about the profile of the surface based on the sound data by:
identifying one or more features in or beneath the surface by comparing baseline sound data and the sound data, the baseline sound data being representative of the acoustic waveguide moving on a reference surface being co-planar.

3. The acoustic sensing system of claim 2, wherein the baseline sound data includes baseline amplitudes as a function of distances between the sound receiving unit and a contact area between the acoustic waveguide and the reference surface, the identifying of the one or more features include:
receiving a position of the acoustic waveguide relative to the mobile robot, the position indicative of a distance along the acoustic waveguide between the sound receiving unit and a contact area between the acoustic waveguide and the surface; and
determining differences between expected amplitudes at the position from the baseline amplitudes and the amplitudes of the sound waves.

4. The acoustic sensing system of claim 3, comprising a sensor operatively connected to the member, the sensor operable to generate a signal indicative of a position of the acoustic waveguide relative to the mobile robot.

5. The acoustic sensing system of claim 4, wherein the sensor is an encoder operatively connected to a motor drivingly engaged to the member.

6. The acoustic sensing system of claim 3, further comprising:
characterizing the one or more features based on the differences between the expected amplitudes and the baseline amplitudes.

7. The acoustic sensing system of claim 2, comprising obtaining the baseline sound data by performing a calibration sequence including:
causing the sound emitting unit to emit the sound waves in the internal volume as the acoustic waveguide moves relative to and in contact with the reference surface; and
receiving the baseline sound data by the sound receiving unit.

8. The acoustic sensing system of claim 7, wherein the calibration sequence further includes:
removing parasitic noise by performing a low-pass filtering of the baseline sound data.

9. The acoustic sensing system of claim 1, wherein the instructions cause the processing unit to:
receive baseline sound data generated by the sound emitting unit, the baseline sound data including the amplitudes of the sound waves reflected by the acoustic waveguide and received by the sound receiving unit over a period of time and at a sampling frequency when the acoustic waveguide is stationary relative to the surface;
receive actual sound data generated by the sound emitting unit, the actual sound data including the amplitudes of the sound waves reflected by the acoustic waveguide and received by the sound receiving unit over the period of time and at the sampling frequency when the acoustic waveguide moves relative to the surface; and
compute the sound data by subtracting the baseline sound data from the actual sound data.

10. The acoustic sensing system of claim 1, wherein the sound emitting unit and the sound receiving unit are components of an acoustic range finder.

11. The acoustic sensing system of claim 1, wherein the member is a wheel rollingly engageable to the frame of the mobile robot.

12. A mobile robot equipped with the acoustic sensing system of claim 1.

13. A method for characterizing a surface on which a mobile robot travels, the method comprising:
emitting sound waves in an internal volume of an acoustic waveguide, the acoustic waveguide being mounted to a member of the mobile robot that moves with movements of the mobile robot relative to the surface;
receiving sound data including amplitudes of the sound waves being reflected by the acoustic waveguide; and
determining information about a profile of the surface based on the sound data.

14. The method of claim 13, wherein the determining of the information about the profile of the surface based on the sound data includes by:
identifying one or more features in the surface by comparing baseline sound data and the sound data, the baseline sound data being representative of the acoustic waveguide moving on a reference surface being co-planar.

15. The method of claim 14, wherein the baseline sound data includes baseline amplitudes as a function of distances between the sound receiving unit and a contact area between the acoustic waveguide and the reference surface, the identifying of the one or more features include:
receiving a position of the acoustic waveguide relative to the mobile robot, the position indicative of a distance along the acoustic waveguide between the sound receiving unit and a contact area between the acoustic waveguide and the surface; and
determining differences between expected amplitudes at the position from the baseline amplitudes and the amplitudes of the sound data.

16. The method of claim 15, comprising receiving a signal from a sensor indicative of a position of the acoustic waveguide relative to the mobile robot.

17. The method of claim 16, wherein the sensor is an encoder operatively connected to a motor drivingly engaged to the member.

18. The method of claim 15, further comprising:
characterizing the one or more features based on the differences between the expected amplitudes and the baseline amplitudes.

19. The method of claim 14, comprising obtaining the baseline sound data by performing a calibration sequence including:
causing the sound emitting unit to emit the sound waves in the internal volume as the acoustic waveguide moves relative to and in contact with the reference surface; and
receiving the baseline sound data by the sound receiving unit.

20. The method of claim 19, wherein the calibration sequence further includes:
removing parasitic noise by performing a low-pass filtering of the baseline sound data.
